(19) United States
(12) Patent Application Publication
(10) Pub. No.: US 2010/0119109 A1
(43) Pub. Date: May 13, 2010

(54) MULTI-CORE MULTI-THREAD BASED KANADE-LUCAS-TOMASI FEATURE TRACKING METHOD AND APPARATUS

(75) Inventors: Hye-mi KIM, Daejeon (KR); Jae Hean Kim, Daejeon (KR); Jung Jae Yu, Daejeon (KR); Jin Ho Kim, Daejeon (KR); Il-Kwon Jeong, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute of Daejeon, Daejeon (KR)

(21) Appl. No.: 12/498,189

(22) Filed: Jul. 6, 2009

(30) Foreign Application Priority Data
Nov. 11, 2008 (KR) 10-2008-0111806
Mar. 20, 2009 (KR) 10-2009-0024051

(51) Int. Cl. G06K 9/00

(52) U.S. Cl. 382/103; 382/190

(57) ABSTRACT

A multi-core multi-thread based Kanade-Lucas-Tomasi (KLT) feature tracking method includes subdividing an input image into regions and allocating a core to each region; extracting KLT features for each region in parallel and in real time; and tracking the extracted features in the input image. Said extracting the features is carried out based on single-region/multi-thread/single-core architecture, while said tracking the features is carried out based on multi-feature/multi-thread/single-core architecture.

### CROSS-REFERENCE(S) TO RELATED APPLICATION(S)

The present invention claims priority of Korean Patent Application No. 10-2008-0111806, filed on Nov. 11, 2008, and Korean Patent Application No. 10-2009-0024051, filed on Mar. 20, 2009, which are incorporated herein by reference.

### FIELD OF THE INVENTION

The present invention relates to a multi-core multi-thread based KLT (Kanade-Lucas-Tomasi) feature tracking method and apparatus; and, more particularly, a method and apparatus that performs subdivision of a high-resolution input image into regions, allocation of a core to each region, real-time KLT feature extraction for each region in parallel and tracking the extracted features.

### BACKGROUND OF THE INVENTION

As well known in the art, image processing includes real-time data extraction from complicated scenes. For example, various kinds of differences on an image recorded by a video camera are identified and tracked.

Camera tracking systems cannot operate in real time, if real-time tracking operation and real-time feature tracking on a two-dimensional image which is an input of the tracking operation are not supported.

Researches for real-time operation of the camera tracking systems by using disclosed algorithms for feature tracking on two-dimensional images have been made so that the real-time operation is insured to some extent.

However, the conventional camera tracking systems cannot track a large number of features in real time, and thus cannot fully support two-dimensional feature tracking.

### SUMMARY OF THE INVENTION

In view of the above, the present invention provides a multi-core multi-thread based KLT feature tracking method and apparatus that performs subdivision of a high-resolution input image into regions, allocation of a core to each region, real-time KLT feature extraction for each region in parallel and tracking the extracted features.

In accordance with an aspect of the present invention, there is provided a multi-core multi-thread based Kanade-Lucas-Tomasi (KLT) feature tracking method including:

subdividing an input image into regions and allocating a core to each region;

extracting KLT features for each region in parallel and in real time; and

tracking the extracted features in the input image.

Said extracting the features for each region may include: applying Gaussian smoothing on the region; extracting horizontal and vertical gradients from the Gaussian-smoothed region; calculating moments and eigenvalues from the extracted gradients; and selecting a specific number of features by sorting the calculated eigenvalues in order of magnitudes thereof.

Said tracking the extracted features may include calculating moments of the extracted features in the input image by using gradients thereof; and estimating displacements of the extracted features in the input image by using the calculated moments, wherein the input image is iteratively sub-sampled to generate a sub-sampled image for each iteration and the sub-sampled images along with the input image form an input image pyramid, in which the input image having the highest pixel resolution serves as a bottom level and the last sub-sampled image having the lowest pixel resolution serves as a top level; wherein said calculating the moments and said estimating the displacement are repeated from the top level of the input image pyramid to the bottom level thereof; and wherein the moments are calculated by using the gradients at a previous level.

Preferably, said estimating the displacement uses Newton-Raphson estimation.

Preferably, said extracting the features is carried out based on single-region/multi-thread/single-core architecture.

Preferably, said tracking the features is carried out based on multi-feature/multi-thread/single-core architecture.

In accordance with another aspect of the present invention, there is provided a multi-core multi-thread based Kanade-Lucas-Tomasi (KLT) feature tracking apparatus including:

a subdivision/allocation unit for subdividing an input image into regions and allocating a core to each region;

a feature extraction unit for extracting KLT features for each region in parallel and in real time; and

a tracking unit for tracking the extracted features in the input image.

The feature extraction unit may include a Gaussian smoothing unit for applying Gaussian smoothing on the region; a gradient extraction unit for extracting horizontal and vertical gradients from the Gaussian-smoothed region; an eigenvalue calculation unit for calculating moments and eigenvalues from the extracted gradients; and a feature selection unit for selecting a specific number of features by sorting the calculated eigenvalues in order of magnitudes thereof.

The tracking unit may include a moment calculation unit for calculating moments of the extracted features in the input image by using gradients thereof; and a displacement estimation unit for estimating displacements of the extracted features in the input image by using the calculated moments, wherein the input image is iteratively sub-sampled to generate a sub-sampled image for each iteration and the sub-sampled images along with the input image form an input image pyramid, in which the input image having the highest pixel resolution serves as a bottom level and the last sub-sampled image having the lowest pixel resolution serves as a top level; wherein calculation of the moments and estimation of the displacement are repeated from the top level of the input image pyramid to the bottom level thereof; and wherein the moments are calculated by using the gradients at a previous level.

Preferably, the displacement estimation unit uses Newton-Raphson estimation.

Preferably, the feature extraction unit has single-region/multi-thread/single-core architecture.

Preferably, the feature tracking unit has multi-feature/multi-thread/single-core architecture.

According to the present invention, a high-resolution input image is subdivided into regions, a core is allocated to each region, KLT features for each region are extracted in parallel and in real time, and feature tracking for the extracted features are performed. Therefore, a large number of features can be tracked in real time and two-dimensional feature tracking can be fully supported.

The method and apparatus of the present invention may perform KLT tracking algorithm on an input image having a pixel resolution of 1024×768 and a frame rate of 30 FPS (Frames per Second) within 0.033 second.

### BRIEF DESCRIPTION OF THE DRAWINGS

The above features of the present invention will become apparent from the following description of embodiments, given in conjunction with the accompanying drawings, in which:

FIG. 1 illustrates a block diagram of multi-core multi-thread based KLT feature tracking apparatus in accordance with an embodiment of the present invention;

FIG. 2 illustrates a block diagram of the KLT feature extraction unit in FIG. 1;

FIG. 3 illustrates a block diagram of the tracking unit in FIG. 1;

FIGS. 4A and 4B illustrate a flowchart of a multi-core multi-thread based KLT feature tracking method performed by the apparatus of FIG. 1;

FIG. 5 illustrates an exemplary view of image subdivision and feature extraction procedures in the method of FIGS. 4A and 4B; and

FIG. 6 illustrates an exemplary view of feature tracking procedure in the method of FIGS. 4A and 4B.

### DETAILED DESCRIPTION OF THE EMBODIMENTS

Hereinafter, embodiments of the present invention will be described in detail with reference to the accompanying drawings, which form a part hereof.

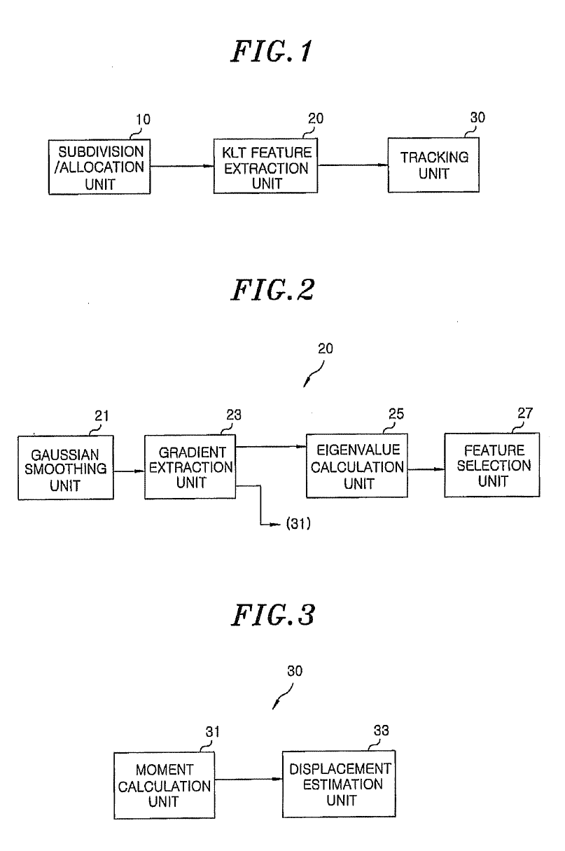

FIG. 1 illustrates a block diagram of multi-core multi-thread based KLT feature tracking apparatus in accordance with an embodiment of the present invention. The multi-core multi-thread based KLT feature tracking apparatus may include a subdivision/allocation unit 10, a KLT feature extraction unit 20 and a tracking unit 30.

The subdivision/allocation unit 10 subdivides a high-resolution input image into regions as many as the number of cores of the apparatus, and allocates a core to each region such that each region can be processed simultaneously in parallel. The subdivision/allocation unit 10 provides the image subdivided into the regions assigned with the cores to the KLT feature extraction unit 20.

The KLT feature extraction unit 20 is a block to extract KLT features of each region in parallel and in real time. As shown in FIG. 2, the KLT feature extraction unit 20 may include a Gaussian smoothing unit 21, a gradient extraction unit 23, an eigenvalue calculation unit 25 and a feature selection unit 27.

The Gaussian smoothing unit 21 applies Gaussian smoothing to each region of the image received from the subdivision/allocation unit 10, and provides the Gaussian-smoothed image to the gradient extraction unit 23.

The gradient extraction unit 23 extracts horizontal and vertical gradients from each region of the Gaussian-smoothed image received from the Gaussian smoothing unit 21, and provides thus extracted horizontal and vertical gradients to the eigenvalue calculation unit 25 and to the tracking unit 30.

The eigenvalue calculation unit 25 calculates moments and eigenvalues from the gradients received from the gradient extraction unit 23, and provides the calculated eigenvalues to the feature selection unit 27.

The feature selection unit 27 sorts the eigenvalues received from the eigenvalue calculation unit 25 in an order of magnitudes thereof to select an appropriate number of features for each region, and provides the selected features to the tracking unit 30.

The tracking unit 30 is a block to track features. As shown in FIG. 3, the tracking unit 30 may include a moment calculation unit 31 and a displacement estimation unit 33.

The moment calculation unit 31 calculates moments of the features received from the feature selection unit 27 by using the gradients received from the gradient extraction unit 23. The moment calculation unit 31 provides the calculated moments to the displacement estimation unit 33.

The displacement estimation unit 33 estimates displacements. To be specific, the displacement estimation unit 33 calculates initial estimated displacements by using the moments received from the moment calculation unit 31, and based thereon, performs Newton-Raphson estimation on displacements between frames around location of the features. In the Newton-Raphson estimation, the input image is iteratively sub-sampled to generate a sub-sampled image for each iteration and the sub-sampled images along with the input image form an input image pyramid. In the Newton-Raphson estimation, the input image having the highest pixel resolution serves as a bottom level and the last sub-sampled image having the lowest pixel resolution serves as a top level. The Newton-Raphson estimation completes displacement estimation when it reaches the bottom level of the input image pyramid.

Below, a multi-core multi-thread based KLT feature tracking method according to the present invention will be described.

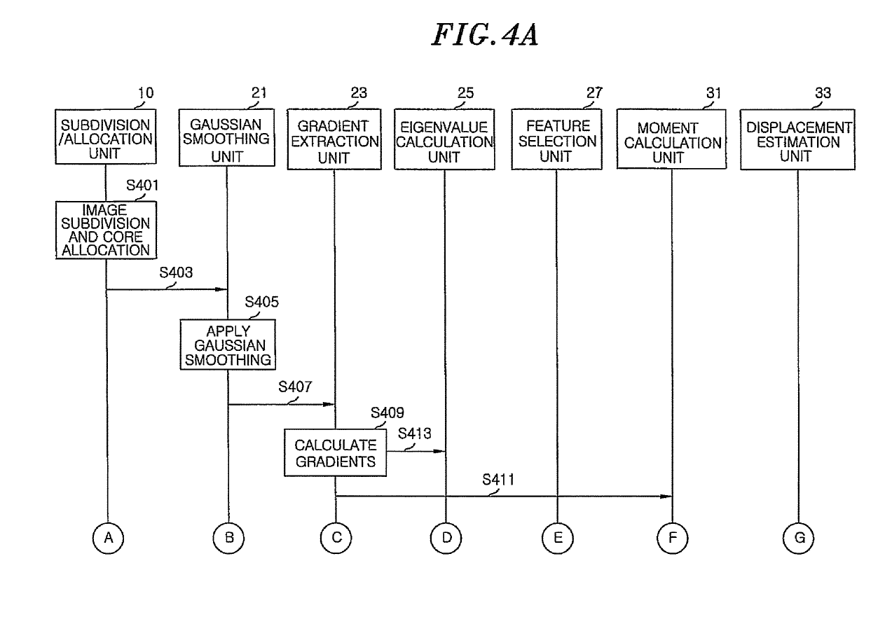

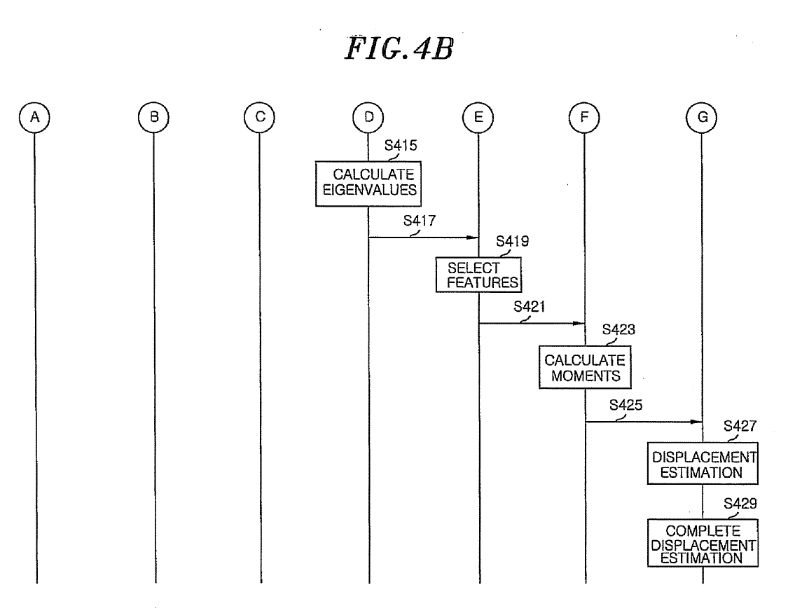

FIGS. 4A and 4B illustrate a flowchart of a multi-core multi-thread based KLT feature tracking method performed by the apparatus of FIG. 1.

First, the subdivision/allocation unit 10 subdivides a high-resolution input image into regions as many as the number of cores of the apparatus, and allocates a core to each region such that each region can be processed simultaneously in parallel (step S401). The subdivision/allocation unit 10 provides the image subdivided into the regions assigned with the cores to the Gaussian smoothing unit 21 of the KLT feature extraction unit 20 (step S403).

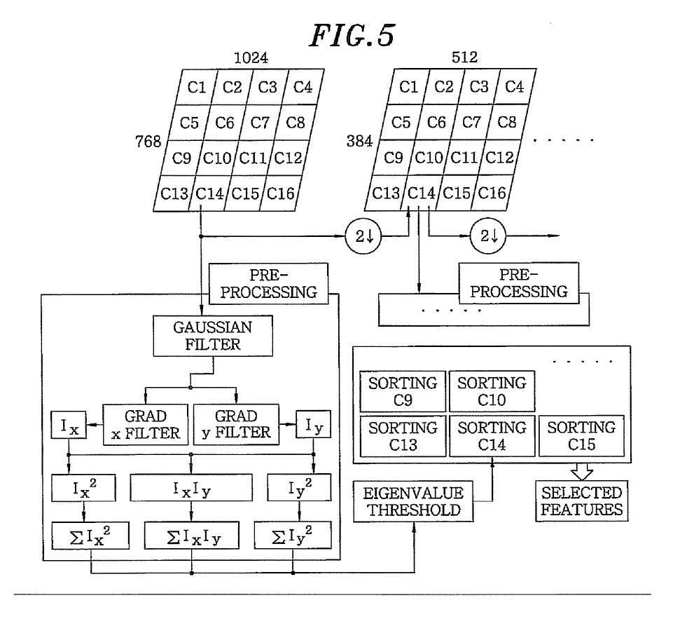

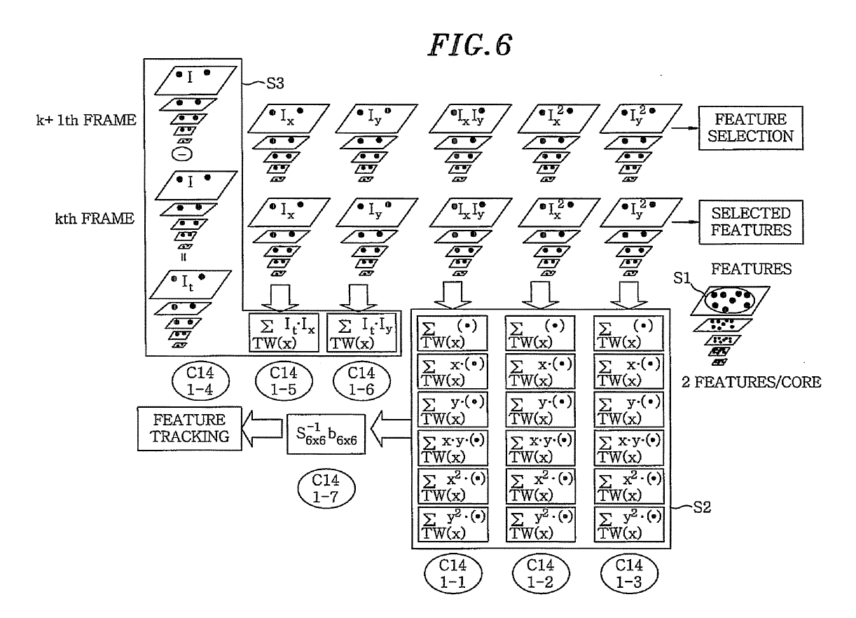

FIG. 5 illustrates an exemplary view of image subdivision and feature extraction procedures in the method of FIGS. 4A and 4B.

The feature tracking apparatus has, e.g., sixteen cores C1 to C16 as shown in FIG. 5. A core allocated to each region performs multiple convolutions via multiple threads. Such single-region/multi-thread/single-core architecture allows a real-time process for each frame. Further, features extracted in a current step of a tracking algorithm and feature locations thereof are used as input in a next step.

Referring back to FIG. 4A, the Gaussian smoothing unit 21 applies Gaussian smoothing to each region of the image received from the subdivision/allocation unit 10 (step S405), and provides the Gaussian-smoothed image to the gradient extraction unit 23 (step S407).

The gradient extraction unit 23 extracts horizontal and vertical gradients from the Gaussian-smoothed image received from the Gaussian smoothing unit 21 (S409), and provides thus extracted horizontal and vertical gradients to the moment calculation unit 31 of the tracking unit 30 (step S411). Further, the gradient extraction unit 23 provides the extracted horizontal and vertical gradients to the eigenvalue calculation unit 25 (step S413).

The eigenvalue calculation unit 25 calculates moments and eigenvalues from the gradients received from the gradient extraction unit 23 (step S415), and provides the calculated eigenvalues to the feature selection unit 27 (step S417).

The feature selection unit 27 sorts the eigenvalues received from the eigenvalue calculation unit 25 in an order of magnitudes thereof to select an appropriate number of features for each region (step S419), and provides the selected features to the moment calculation unit 31 of the tracking unit 30 (step S421).

The moment calculation unit 31 calculates moments of the features received from the feature selection unit 27 by using the gradients received from the gradient extraction unit 23 (step S423). The moment calculation unit 31 provides the calculated moments to the displacement estimation unit 33 (step S425).

The displacement estimation unit 33 estimates displacements. To be specific, the displacement estimation unit 33 calculates initial estimated displacements by using the moments received from the moment calculation unit 31 (step S427), and based thereon, repeats the Newton-Raphson estimation on displacements between frames around location of the features until it reaches the bottom level of the input image pyramid, thereby completing displacement estimation (step S429).

FIG. 6 illustrates an exemplary view of feature tracking procedure in the method of FIGS. 4A and 4B. The feature tracking procedure is based on multi-feature/multi-thread/single-core architecture. In FIG. 6, reference symbols C14 1-1 to C14 1-6 represent threads in the fourteenth core of the feature tracking apparatus, and small points in a circle S1 represent features whose displacements are to be estimated.

Displacement estimation of the features is started at the top level of the input image pyramid. In a box S2, eighteen moments are calculated to obtain a 6×6 matrix S. In a box S3, differences in brightness between frames are calculated to obtain a 6×1 vector b. An estimated displacement matrix x is obtained from a linear algebra equation S·x=b. Solutions of the box S3 and S·x=b are calculated until displacements in the matrix x converge, and thus converged displacements are determined as initial estimated locations at the next level of the input image pyramid. At the next level, initial estimated locations at the following level of the input image pyramid are determined through an identical procedure. Such procedure is repeated until it reaches the bottom level of the input image pyramid, thereby completing the displacement estimation.

In the displacement estimation, calculation of the differences in brightness between frames in regions around the features needs to be repeated, and the moments of the features extracted during the feature extraction are required. Further, inverse operation of a matrix using the Gauss elimination is necessary to calculate a solution for a linear algebra equation, e.g., S·x=b. In order to reduce load for the above-describe calculation, the multi-feature/multi-thread/single-core architecture in the single-region/multi-thread/single-core architecture selected for the feature extraction is adopted. In the multi-feature/multi-thread/single-core architecture, multiple features are corresponded with single core and multiple threads are used for displacement estimation of the respective features.

While the invention has been shown and described with respect to the embodiments, it will be understood by those skilled in the art that various changes and modification may be made without departing from the scope of the invention as defined in the following claims.

What is claimed is:

1. A multi-core multi-thread based Kanade-Lucas-Tomasi (KLT) feature tracking method comprising:
subdividing an input image into regions and allocating a core to each region;
extracting KLT features for each region in parallel and in real time; and
tracking the extracted features in the input image.

2. The method of claim 1, wherein said extracting the features for each region includes:
applying Gaussian smoothing on the region;
extracting horizontal and vertical gradients from the Gaussian-smoothed region;
calculating moments and eigenvalues from the extracted gradients; and
selecting a specific number of features by sorting the calculated eigenvalues in order of magnitudes thereof.

3. The method of claim 1, wherein said tracking the extracted features includes:
calculating moments of the extracted features in the input image by using gradients thereof; and
estimating displacements of the extracted features in the input image by using the calculated moments,
wherein the input image is iteratively sub-sampled to generate a sub-sampled image for each iteration and the sub-sampled images along with the input image form an input image pyramid, in which the input image having the highest pixel resolution serves as a bottom level and the last sub-sampled image having the lowest pixel resolution serves as a top level;
wherein said calculating the moments and said estimating the displacement are repeated from the top level of the input image pyramid to the bottom level thereof; and
wherein the moments are calculated by using the gradients at a previous level.

4. The method of claim 3, wherein said estimating the displacement uses Newton-Raphson estimation.

5. The method of claim 1, wherein said extracting the features is carried out based on single-region/multi-thread/single-core architecture.

6. The method of claim 1, wherein said tracking the features is carried out based on multi-feature/multi-thread/single-core architecture.

7. A multi-core multi-thread based Kanade-Lucas-Tomasi (KLT) feature tracking apparatus comprising:
a subdivision/allocation unit for subdividing an input image into regions and allocating a core to each region;
a feature extraction unit for extracting KLT features for each region in parallel and in real time; and
a tracking unit for tracking the extracted features in the input image.

8. The apparatus of claim 7, wherein the feature extraction unit includes:
a Gaussian smoothing unit for applying Gaussian smoothing on the region;
a gradient extraction unit for extracting horizontal and vertical gradients from the Gaussian-smoothed region;
an eigenvalue calculation unit for calculating moments and eigenvalues from the extracted gradients; and
a feature selection unit for selecting a specific number of features by sorting the calculated eigenvalues in order of magnitudes thereof.

9. The apparatus of claim 7, wherein the tracking unit includes:
a moment calculation unit for calculating moments of the extracted features in the input image by using gradients thereof; and
a displacement estimation unit for estimating displacements of the extracted features in the input image by using the calculated moments,
wherein the input image is iteratively sub-sampled to generate a sub-sampled image for each iteration and the sub-sampled images along with the input image form an input image pyramid, in which the input image having the highest pixel resolution serves as a bottom level and the last sub-sampled image having the lowest pixel resolution serves as a top level;
wherein calculation of the moments and estimation of the displacement are repeated from the top level of the input image pyramid to the bottom level thereof; and
wherein the moments are calculated by using the gradients at a previous level.

10. The apparatus of claim 9, wherein the displacement estimation unit uses Newton-Raphson estimation.

11. The apparatus of claim 7, wherein the feature extraction unit has single-region/multi-thread/single-core architecture.

12. The apparatus of claim 7, wherein the feature tracking unit has multi-feature/multi-thread/single-core architecture.
